(19) United States
(12) Patent Application Publication
(10) Pub. No.: US 2023/0403064 A1
(43) Pub. Date: Dec. 14, 2023

(54) DETERMINING TIMES FOR APPLYING BEAM STATES FOR UPLINK TRANSMISSIONS

(71) Applicant: ZTE CORPORATION, Shenzhen (CN)

(72) Inventors: Ke YAO, Shenzhen (CN); Bo GAO, Shenzhen (CN); Chuangxin JIANG, Shenzhen (CN); Shujuan ZHANG, Shenzhen (CN); Zhaohua LU, Shenzhen (CN)

(73) Assignee: ZTE CORPORATION, Shenzhen (CN)

(21) Appl. No.: 18/326,697

(22) Filed: May 31, 2023

Related U.S. Application Data
(63) Continuation of application No. PCT/CN2021/071874, filed on Jan. 14, 2021.

(51) Int. Cl. H04B 7/06; H04L 5/00; H04W 72/20

(52) U.S. Cl. CPC H04B 7/06966; H04L 5/001; H04W 72/20; H04L 5/0055

(57) ABSTRACT

Presented are systems, methods, apparatuses, or computer-readable media for determining times for applying beam states for uplink transmissions. A wireless communication device may receive, from a wireless communication node, a first downlink control information (DCI) indicating a beam state. The wireless communication device may determine to apply the beam state to at least one target transmission after or starting from a first application time.

### CROSS-REFERENCE TO RELATED APPLICATION

This application claims the benefit of priority under 35 U.S.C. § 120 as a continuation of PCT Patent Application No. PCT/CN2021/071874, filed on Jan. 14, 2021, the disclosure of which is incorporated herein by reference in its entirety.

### TECHNICAL FIELD

The disclosure relates generally to wireless communications, including but not limited to systems and methods for determining times for applying beam states for uplink transmissions.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, a method, an apparatus, or a computer-readable medium. A wireless communication device may receive, from a wireless communication node, a first downlink control information (DCI) indicating a beam state. The wireless communication device may determine to apply the beam state to at least one target transmission after or starting from a first application time.

In some embodiments, the first application time may be determined according to at least one of a reference time or a time offset. In some embodiments, the first application time may be determined by applying the time offset after the reference time, or by applying the time offset after a first time unit occurring after the reference time.

In some embodiments, the reference time may include one of: a time unit during which the wireless communication device receives the first DCI; a time unit during which the wireless communication device would transmit a physical uplink control channel (PUCCH) or a physical uplink shared channel (PUSCH) with hybrid automatic repeat request acknowledgement (HARQ-ACK) information for the first DCI; or a time unit during which the wireless communication device would transmit a PUCCH or PUSCH with HARQ-ACK information for a physical downlink shared channel (PDSCH) scheduled by the first DCI.

In some embodiments, the time offset may include X time units. X may be: a predefined value, a value indicated by the first DCI, or a value configured by radio resource control (RRC) or medium access control control element (MAC-CE) signaling. In some embodiments, X may be a value indicated by time domain resource assignment (TDRA) field in the first DCI. In some embodiments, the time unit may include at least one of: a subframe, a frame, an orthogonal frequency-division multiplexing (OFDM) frame, a millisecond, a microsecond, a second, a slot, a symbol, or an OFDM symbol.

In some embodiments, the beam state may include at least one of: a quasi co-location (QCL) state, a transmission configuration indicator (TCI) state, spatial relation information, reference signal information, spatial filter information, or precoding information.

In some embodiments, the wireless communication device may receive, from the wireless communication node in a first component carrier (CC) of a group of CCs, the first downlink control information (DCI) indicating the beam state. In some embodiments, the wireless communication device may determine to apply the beam state to at least one target transmission on at least one CC of the group of CCs after or starting from the first application time.

In some embodiments, a time unit of the first application time may be determined according to at least one of: a smallest subcarrier spacing (SCS) amongst one or more SCS configurations of one or more active bandwidth parts (BWPs) in the group of CCs; or a smallest of the one or more SCS configurations of the one or more active BWPs in the group of CCs and of one or more SCS configurations of an active BWP for a physical downlink control channel (PDCCH) reception.

In some embodiments, the first application time may be determined according to a completion time of a set of transmission repetitions of a first target transmission in one CC of the group of CCs. In some embodiment, the wireless communication device may determine, after or starting from the application time, pathloss information for the at least one target transmission, according to the beam state.

In some embodiments, the first application time or a minimum value of the first application time may be based on a capability of the wireless communication device. In some embodiments, the first application time or the minimum value of the first application time may be configured or indicated by the wireless communication node.

In some embodiments, the first application time or a minimum value of the first application time may be determined based on a capability of the wireless communication device for a CC or CC group, for a band or band group, for a BWP, or for a SCS configuration. In some embodiments, the first application time or the minimum value of the first application time may be configured or indicated by the wireless communication node for a CC or CC group, for a band or band group, for a BWP, or for each SCS configuration.

In some embodiments, the wireless communication device may receive, from the wireless communication node, a second DCI with a type A DCI format. In some embodiments, the wireless communication device may determine to apply the beam state to a first target transmission that occurs after or starting from the first application time, the target transmission comprising a physical uplink shared channel (PUSCH) scheduled by the second DCI.

In some embodiments, the wireless communication device may receive, from the wireless communication node, a second DCI with a type A DCI format. In some embodiments, the wireless communication device may determine to apply the beam state to a first target transmission if the second DCI occurs after the first application time, the target transmission comprising a physical uplink shared channel (PUSCH) scheduled by the second DCI.

In some embodiments, the wireless communication device may determine to apply the beam state to a sounding reference signal (SRS) transmission, after the first application time. In some embodiments, the wireless communication device may receive, from the wireless communication node, a second DCI with a type B DCI format. In some embodiments, the wireless communication device may determine a transmit parameter of the target transmission, according to a latest SRS transmission in time domain based on the target transmission, or a transmission or reception of the second DCI.

In some embodiments, the latest SRS transmission in time domain may include a latest SRS transmission or a latest applicable SRS transmission occurring before (start of) the target transmission, or before the (completion of) transmission or reception of the second DCI. In some embodiments, the latest applicable SRS transmission may include a SRS transmission that becomes applicable after a second application time.

In some embodiments, the second application time may be determined according to a physical uplink shared channel (PUSCH) scheduled by the second DCI, and is after or starting from the completion of the PUSCH. In some embodiments, the second DCI may occur after the first DCI or after the SRS, and before a first time period after the SRS transmission/

In some embodiments, the wireless communication device may receive, from the wireless communication node, a second DCI. In some embodiments, the wireless communication device may determine to apply the beam state to a first target transmission after or starting from an application time, the target transmission comprising a physical uplink shared channel (PUSCH) transmission scheduled by the second DCI, if at least one condition is met.

In some embodiments, the at least one condition may include at least one of: the second DCI is of a type B DCI format; a rank value or a maximum rank value of the PUSCH transmission is 1; a number of layer, transmission layer or maximum layer of the PUSCH transmission is 1; a number of port or antenna port of the PUSCH transmission is 1; a number of demodulation reference signal (DMRS) port of the PUSCH transmission is 1; a sounding reference signal (SRS) resource indicator (SRI) field is not present in the second DCI; absence of a SRS request field in the second DCI, or a SRS field of the second DCI is set with a value of 0; an UL-SCH indicator field in the second DCI is set with a value of 0; a special transmit precoding matrix index (TPMI) parameter is set with a predefined value in the second DCI; a precoding information and number of layers field in the second DCI is set as a reserved value; or PUSCH repetition Type A is configured or indicated for the PUSCH transmission, and a number of repetitions that is larger than 1.

In some embodiments, the type A DCI format may include a DCI format 0_0. In some embodiments, the type B DCI format may include a DCI format 0_1, a DCI format 0_2 or a uplink DCI format other than DCI format 0_0.

At least one aspect is directed to a system, a method, an apparatus, or a computer-readable medium. A wireless communication node may transmit, to a wireless communication device, a first downlink control information (DCI) indicating a beam state. The wireless communication device may be caused to apply the beam state to at least one target transmission after or starting from a first application time.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3A illustrates a block diagram of a system for determining times to apply transmission configuration indicators (TCIs) in carrier aggregation (CA) scenarios for physical downlink shared channel (PDSCH) transmissions in accordance with illustrative embodiments;

FIG. 3B illustrates a block diagram of a system for determining times to apply transmission configuration indicators (TCIs) in carrier aggregation (CA) scenarios based on slot boundaries of physical downlink shared channel (PDSCH) transmissions in accordance with illustrative embodiments;

FIG. 3C illustrates a block diagram of a system for determining times to apply transmission configuration indicators (TCIs) in carrier aggregation (CA) scenarios based on completion of last repetition of physical downlink shared channel (PDSCH) transmissions in accordance with illustrative embodiments;

FIG. 4A illustrates a block diagram of a system for times to apply transmission configuration indicators (TCIs) for physical uplink shared channel (PUSCH) transmissions in accordance with illustrative embodiments;

FIG. 4B illustrates a block diagram of a system for times to apply transmission configuration indicators (TCIs) for physical uplink shared channel (PUSCH) transmissions in subsequent time periods in accordance with illustrative embodiments; and

FIG. 5 illustrates a flow diagram of a method of determining times for applying beam states for uplink transmissions in accordance with illustrative embodiments.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

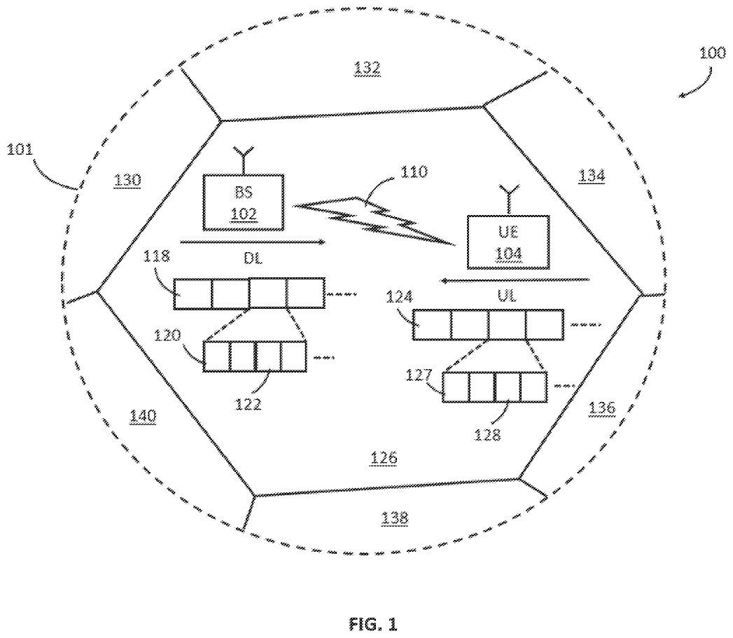

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

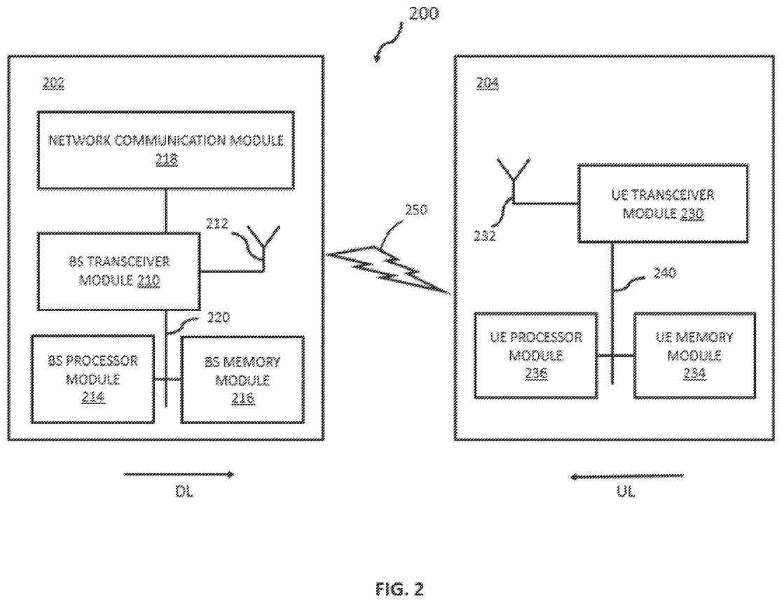

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Timing the Application of Transmission Configuration Indicators (TCIs) in Multiple Transmission Reception Point (MTRP) Environments

In multiple transmission reception point (MTPR) environments, there may be potentially at least two issues. First, one or two transmission configuration indicators (TCIs) indicated by downlink control information (DCI) may be applied to target channels or transmissions. On the other hand, a physical downlink control channel (PDCCH) and a physical uplink control channel (PUCCH) may be configured with one or two TCI, spatial relationships, or beams. Which TCI in the DCI is to be applied to a corresponding TCI, spatial relationship, or beam of PDCCH and PUCCH may be not clear. Second, in carrier aggregation (CA), when component carriers (CCs) are configured with different subcarrier spacings (SCSs), how to determine the effective time for the TCI in the DCI for the target channels may not be clear.

One feature in new radio (NR) technology of fifth generation (5G) mobile communication systems may be the support of high frequency bands. High frequency bands may have abundant frequency domain resources, but wireless signals in high frequency bands may decay quickly and coverage of the wireless signals may decrease. As such, transmitting signals in a beam mode may be able to concentrate energy in a relatively small spatial range and improve the coverage of the wireless signals in the high frequency bands. In the beam scenario, as the time and position change, a beam pair between a base station and a user equipment (UE) may also change. A flexible beam update mechanism may thus be desired. Under one approach, NR technology may support a beam mechanism with an assumption that the UE has a single panel or communicates with a single transmission and reception point (TRP). This mechanism may not be able to indicate the beams for multiple channels, multiple panels, or in a multiple TRPs scenario.

With unified TCI architecture, TCI state can be applied to uplink and downlink, data and control channels. For example, the beam state (also referred as TCI state, common TCI state, or common beam state) indicated by the DCI may be applied to at least one of multiple channels (e.g., a target transmission). The channel may include, for example, a physical downlink shared channel (PDSCH), physical downlink control channel (PDCCH), physical uplink control channel (PUCCH), physical uplink shared channels (PUSCH), sounding reference signal (SRS), or channel state information reference signal (CSI-RS), among others. The beam state may include quasi-co-location (QCL) information, a TCI state, spatial relation information, reference signal information, spatial filter information, or precoding information, among others. Carrier aggregation (CA) may include at least one component carrier (CC). A CC may include at least one bandwidth part (BWP). The configuration from a gNB to a UE may be in a CC, or in the BWP within a CC. A configuration in a CC may identify a configuration in one BWP or multiple configurations in multiple BWPs.

### A. Unified Transmission Configuration Indicator (TCI) States in Carrier Aggregation Scenarios

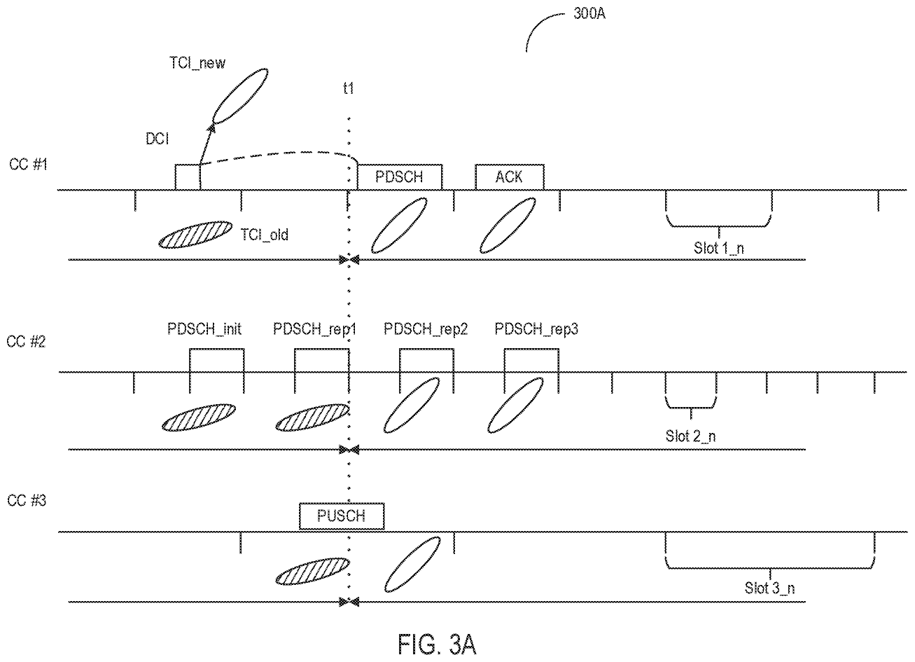

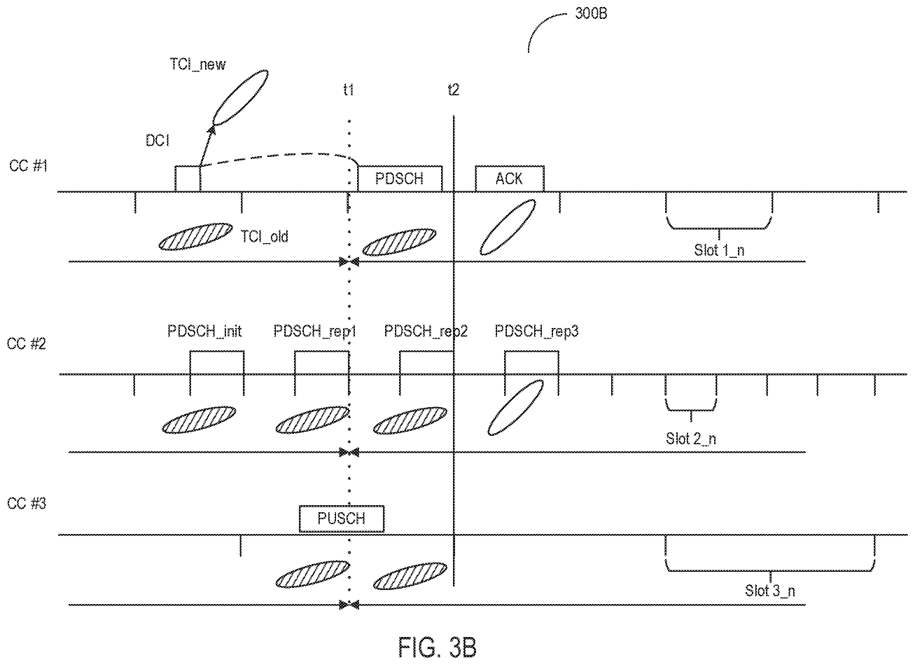

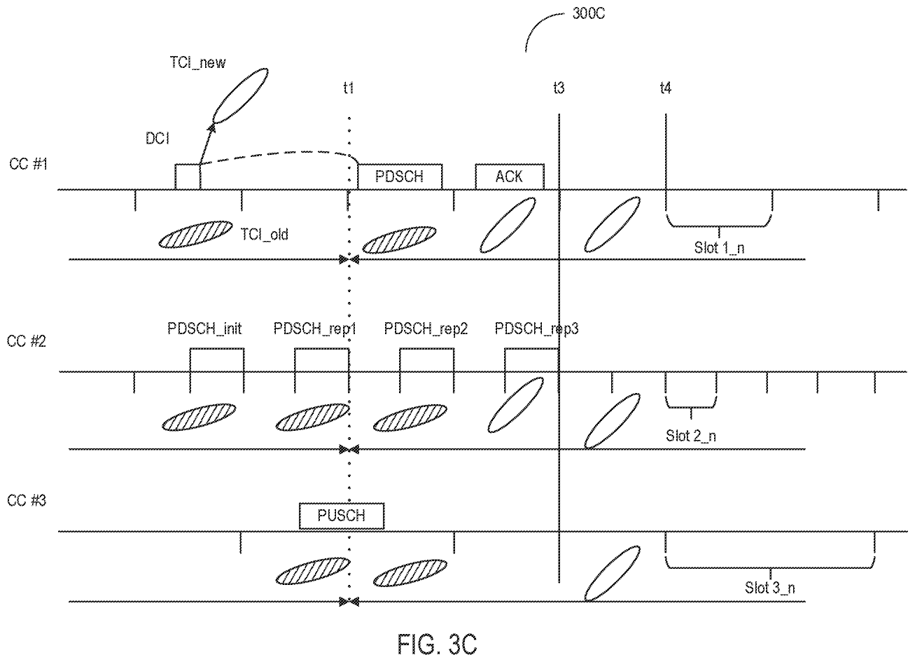

Referring now to FIG. 3A, depicted is a block diagram of a system 300A for determining times to apply transmission configuration indicators (TCIs) in carrier aggregation (CA) scenarios for physical downlink shared channel (PDSCH) transmissions. In case of CA, there may be more than one CC in a CC group. As shown, there are 3 CCs: CC #1, CC #2, CC #3. The CCs may be configured with different sub-carrier space (SCS), so the CCs may have different lengths of slots. For example, in CC #1 a DCI scheduling a PDSCH transmission indicates a TCI state (e.g. TCI state_new). TCI state_new may be expected to be applied to target transmissions after time point t1. The application time for a TCI state in a DCI (e.g., t1) may depend on one or more of the following factors: DCI time, DCI scheduled/triggered transmission time (of a target transmission), response for DCI, response for the scheduled transmission, processing time of NB or UE, or some additional time periods. t1 may be set at the boundary of a slot or orthogonal frequency-division multiplexing (OFDM) symbol of CC #1, but t1 may not be at the boundary of slot or OFDM symbol for other CCs due to different SCS configuration (also referred herein as different numerology).

Generally, a transmission may be scheduled within a slot in a CC, but a transmission in a CC with smaller SCS (longer slot or symbol) can occupy a time period that overlaps with more than one slot for a CC with larger SCS (shorter slot/symbol). For example, a PUSCH transmission in CC #3 may overlap with 2 slots in CC #2 and 2 halves of continuous slots in CC #1.

As shown, TCI_new may be applied to target transmissions after t1. The target transmission(s) may include at least one of physical downlink shared channel (PDSCH), physical uplink shared channel (PUSCH), physical downlink control channel (PDCCH), physical uplink control channel (PUCCH), channel state information reference signal (CSI-RS), or sounding reference signal (SRS). The target transmissions can be on more than one CC. When TCI_new starts to be effective at t1, beam of target transmission may be switched from a beam indicated by TCI_old to a beam indicated by TCI_new.

For CC #2, PDSCH_init that is an initial transmission of a PDSCH transmission, and PDSCH_rep1, PDSCH_rep2, PDSCH_rep3 may be repetitions of the PDSCH transmission. With above description, PDSCH_init and PDSCH_rep1 may be transmitted using TCI_old, while PDSCH_rep2, PDSCH_rep3 may be transmitted using TCI_new. It may introduce some inconvenience for the UE. For CC #3, PUSCH may be transmitted using TCI_old at first, but beam may be expected to be changed to TCI_new after t1. However, transmissions in this manner may present challenges.

To avoid the above mentioned issues, a TCI state may be indicated by a gNB to a UE in the first CC. The TCI state may be applied to a target transmission after or no earlier than an application time. The target transmissions can be on any CC of a CC group which includes the first CC. The application time may be determined according to at least one of: (a) a smallest SCS of a CC in the CC group; (b) a longest length of a slot of a CC in the CC group; (c) a longest length of a symbol of a CC in the CC group; (d) the completion of a set of transmission repetitions in a CC of the CC group; or (e) the TCI state can be used for determining pathloss for the target transmission after the application time.

An SCS of a CC may refer to an SCS configured for an active BWP in the CC, or a smallest SCS configured for all BWPs in the CC. Similarly, a length of slot or symbol (OFDM symbol) may refer to a length of an active BWP in the CC, or a longest slot or symbol configured for all BWPs in the CC. The set of transmission repetitions in a CC may refer to at least one transmission repetition which may use a same (set of) TCI state. Beam or TCI state may not be allowed to change among transmission repetitions within the set of transmission repetitions. For example, there may be 4 repetitions for a PDSCH transmission: PDSCH_init, PDSCH_rep1, PDSCH_rep2, and PDSCH_rep3. The set of transmission repetitions may include all or part of the 4 repetitions. The target transmission may include at least one of PDSCH, PUSCH, PDCCH, PUCCH, CSI-RS, or SRS.

Referring now to FIG. 3B, depicted is a block diagram of a system 300B for determining times to apply transmission configuration indicators (TCIs) in carrier aggregation (CA) scenarios based on slot boundaries of physical downlink shared channel (PDSCH) transmissions. As shown, the application time for a TCI state in a DCI (e.g., t1) may depend on one or more of the following factors: DCI time, DCI scheduled or triggered transmission time, response for DCI, response for the scheduled transmission, processing time of NB or UE, or some additional time periods. t1 may be set at the boundary of slot or OFDM symbol of CC #1, but if t1 is not at the boundary of slot of CC #3, then beam or TCI state changing may happen during (in the middle of) a PUSCH transmission. If a longest slot of a CC in the CC group is adopted to determine the application time, the application time may be delayed to the latest slot boundary of CC #3, which is t2. The TCI_new may be applied to target transmission in CC #1, CC #2 and CC #3 after or no earlier than t2.

Referring now to FIG. 3C, depicted is a block diagram of a system 300C for determining times to apply transmission configuration indicators (TCIs) in carrier aggregation (CA) scenarios based on completion of last repetition of physical downlink shared channel (PDSCH) transmissions. As shown, the application time for a TCI state in a DCI (e.g. t1), may cause a beam or TCI state changing or transition to happen during PDSCH repetitions. PDSCH_init and PDSCH_rep1 may share the same TCI state (e.g., TCI_old), while PDSCH_rep2 and PDSCH_rep3 may share another TCI state, i.e. TCI_new. If a set of PDSCH repetitions that includes all the 4 PDSCH repetitions is expected to apply a same beam or TCI state, which means beam or TCI state changing is not allowed during the set of PDSCH repetitions, the application time may be delayed to the completion of the last repetition (PDSCH_rep3), which is t3. TCI_new may be applied to target transmissions in CC #1, CC #2 and CC #3 after or no earlier than t3.

### B. Unified Transmission Configuration Indicator (TCI) States for Physical Uplink Shared Channel (PUSCH)

A PUSCH transmission can be scheduled (also referred to “be activated”) by a DCI, such as DCI format 0_0, DCI format 0_1, or DCI format 0_2. There may be no SRI field in DCI format 0_0. However, there can exist SRI field in DCI format 0_1 or DCI format 0_2. A PUSCH transmission scheduled by a DCI format 0_0 cannot be transmitted in MIMO mode, since there is no MIMO parameter in DCI format 0_0. While DCI format 0_1, or DCI format 0_2 can support MIMO parameters, so a PUSCH transmission scheduled by a DCI format 0_1 or DCI format 0_2 can be transmitted in MIMO mode. Therefore, a PUSCH transmission scheduled by a DCI format 0_1 or DCI format 0_2 may depend on SRI that corresponds to SRS transmission.

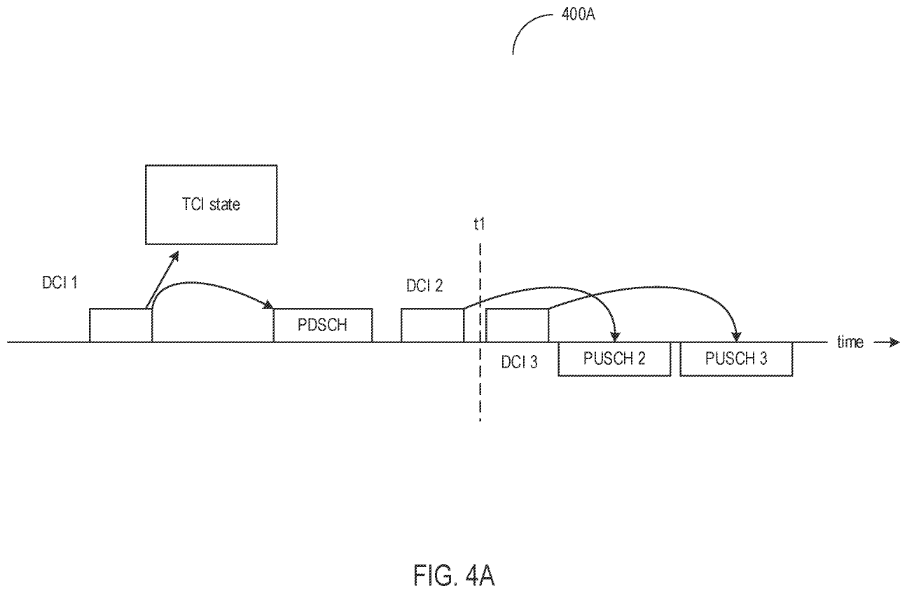

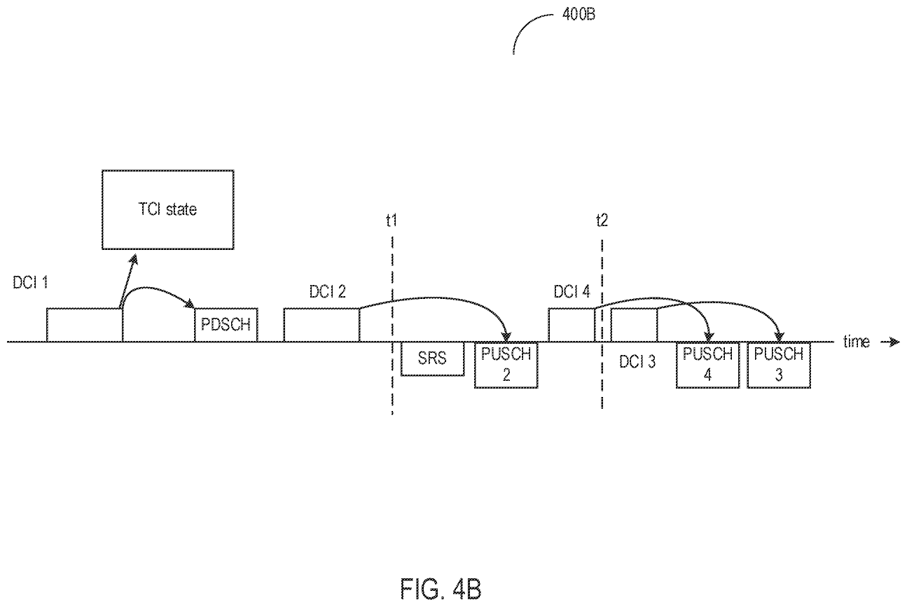

Referring now to FIG. 4A, depicted is a block diagram of a system 400A for times to apply transmission configuration indicators (TCIs) for physical uplink shared channel (PUSCH) transmissions. In unified TCI framework, when a common TCI state is applicable (also referred to “effective”), the common TCI state can be applied to a PUSCH transmission, as long as the PUSCH transmission is scheduled by a DCI format 0_0, and the PUSCH transmission starts after the common TCI state is applicable. For example as shown, DCI 1 may indicate a TCI state that is a common TCI state, and the TCI state may be applicable at time point t1. PUSCH 2 and PUSCH 3 may be PUSCH transmissions scheduled by DCI 2 and DCI 3 respectively, and DCI 2 and DCI 3 may be DCI format 0_0 since PUSCH 2 and PUSCH 3 may start after t1, so the common TCI state can be applied to PUSCH 2 and PUSCH 3.

Further, in unified TCI framework, when a common TCI state is applicable, the common TCI state can be applied to a PUSCH transmission, as long as the PUSCH transmission is scheduled by a DCI format 0_0, and the PUSCH transmission starts after the common TCI state is applicable, and the DCI (DCI2) that scheduled the PUSCH transmission is after the DCI (DCI1) that indicated the common TCI. For example as shown, DCI 1 may indicate a TCI state that is a common TCI state, and the TCI state may be applicable at time point t1. PUSCH 2 may be a PUSCH transmission scheduled by DCI 2 and that is DCI format 0_0. PUSCH 2 may start after t1, and DCI 2 may be after DCI 1, and thus the common TCI state can be applied to PUSCH 2 and PUSCH 3.

In unified TCI framework, when a common TCI state is applicable, the common TCI state can be applied to a SRS transmission. When the SRS transmission is applicable, the SRS transmission may be applied to PUSCH transmission scheduled by a DCI format 0_1 or DCI format 0_2. For example as shown, DCI 1 may indicate a TCI state that is a common TCI state, and the TCI state may be applicable at time point t1. SRS may be an SRS transmission which is after t1. SRS may be an SRS transmission transmitted by UE, and a gNB may receive and measure the SRS transmission. There may be an application time for SRS (e.g., t2). Before t2, the SRS transmission cannot be a reference for a PUSCH transmission (e.g., the PUSCH 2) scheduled by DCI 2. Then PUSCH 2 may refer to another earlier SRS transmission before the SRS (e.g. an old SRS). After t2, the SRS transmission can be a reference for a PUSCH transmission (e.g. PUSCH 3) scheduled by DCI 3.

Referring now to FIG. 4B, depicted is a block diagram of a system 400B for times to apply transmission configuration indicators (TCIs) for physical uplink shared channel (PUSCH) transmissions in subsequent time periods. As shown, DCI 4 may be earlier than t2 that is the application time for the SRS, and PUSCH 4 that is scheduled by the DCI 4 may be after t2. The following methods can be adopted by PUSCH 4 for SRS determination. In some embodiments (method 1), PUSCH 4 can refer to the SRS (new SRS), since PUSCH 4 is after t2. That is, as long as PUSCH transmission is after the application time of a new SRS, the new SRS can be applied to the PUSCH transmission. The PUSCH transmission may be scheduled by a DCI format 0_1 or 0_2. In some embodiments (method 2), DCI 4 may be earlier than t2. gNB may indicate scheduling or grant information for PUSCH 4 based on an earlier old SRS in DCI 4. Thus, PUSCH 4 can refer to an old SRS. If the DCI is earlier than an application time of a new SRS, the new SRS cannot be applied to the PUSCH that is scheduled by the DCI. In other words, an old SRS that is earlier than the new SRS may be adopted for the PUSCH.

There may be a drawback under method 2 in the case of carrier aggregation (CA). Assuming there are more than one CC, on one CC, situation is as shown. t2 may be the application time for SRS, and t2 may be used for a group of CCs. After t2, new SRS may be used for PUSCH on each of the CCs. With method 2, an old TCI may be used for PUSCH 4, if there is another PUSCH transmission that uses new SRS in another CC overlapping in time with PUSCH 4, it may not be realized. There may be following two ways to solve this issue.

Under one method, UE may not expect to receive a DCI before an application time of an SRS and the DCI may schedule a PUSCH transmission after the application time of the SRS. That means, it may be up to gNB or network to avoid the above issue. Under another method, an application time of an SRS may be determined based on a PUSCH transmission scheduled by a DCI format 0_1 or 0_2. The DCI format 0_1 or 0_2 may be after the DCI that indicates the common TCI state or after the SRS, and before a first time period after the SRS, (e.g., before t2) (the original application time for the SRS). Then the application time of the SRS may be determined after completion of the PUSCH transmission.

From above description, for a PUSCH transmission scheduled by a DCI format 0_1 or 0_2, a common TCI state may be indicated by a DCI. The common TCI state may be firstly applicable for SRS, and the common TCI state can affect the PUSCH transmission after a period when the new SRS is applicable. A longer time may be taken than a common TCI state indicated in a DCI for a PUSCH scheduled by a DCI format 0_0. In some cases, a common TCI may be expected to be applied to a PUSCH transmission as soon as possible. Thus, if only DCI format 0_0 can be used, the limit may be too strict. Therefore, it may allow a PUSCH transmission scheduled by a DCI format 0_1 or 0_2 to use a common TCI state indicated by a DCI, and SRS can be skipped.

In unified TCI framework, when a common TCI state is applicable, the common TCI state can be applied to a PUSCH transmission that starts after the common TCI state is applicable, if the PUSCH transmission meets at least one of the following conditions: (a) the PUSCH transmission is scheduled by a DCI format 0_1 or a DCI format 0_2; (b) a rank value or a maximum rank value of the PUSCH transmission is 1; (c) a number of layer or transmission layer or a maximum layer of the PUSCH transmission is 1; (d) a number of port or antenna port of the PUSCH transmission is 1; (e) a number of DMRS port of the PUSCH transmission is 1; (f) SRI field is not present in the DCI which scheduled the PUSCH transmission; (g) SRS request field in the DCI which scheduled the PUSCH transmission is not present or equals 0; (h) UL-SCH indicator field in the DCI which scheduled the PUSCH transmission equals 0; (i) a special TPMI e.g. is set with a reserved value, indicated by the DCI which scheduled the PUSCH transmission; or (i) PUSCH repetition Type A is configured or indicated for the PUSCH transmission, and a number of repetitions K is larger than 1.

With one or a combination of the above conditions, the PUSCH transmission may be transmitted with a single layer (transmission layer or MIMO layer). The SRS may be thus not relied upon, then the transmit parameter (e.g., beam state information) can be derived from the common TCI state in the DCI. Therefore, the effective common TCI state can be applied to the PUSCH transmission earlier than for the PUSCH transmission scheduled by a DCI format 0_1 or a DCI format 0_2 without the above limitation.

### C. Process for Determining Times for Applying Beam States for Uplink Transmissions

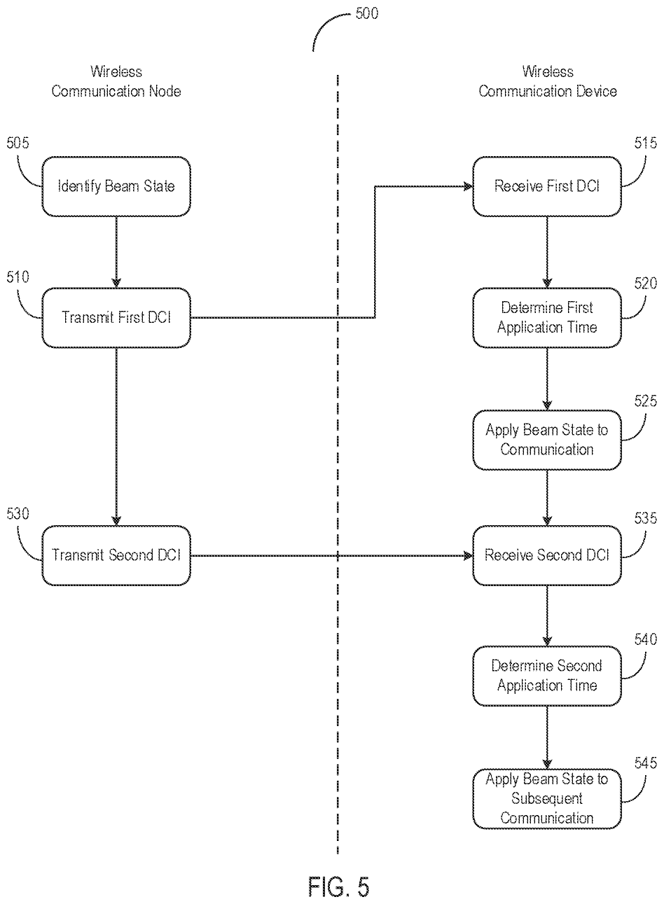

Referring now to FIG. 5, depicted is a flow diagram of a method 500 of determining times for applying beam states for uplink transmissions. The method 500 may be performed by or implemented using any of the components discussed above, such as the BS 102, UE 104, BS 202, or the UE 204, among others. In brief overview, a wireless communication node may identify a beam state (505). The wireless communication node may transmit first downlink control information (DCI) (510). A wireless communication device may receive the first DCI (515). The wireless communication device may determine a first application time (520). The wireless communication device may apply the beam state to a communication (525). The wireless communication node may transmit second DCI (530). The wireless communication device may receive the second DCI (535). The wireless communication device may determine a second application time (540). The wireless communication device may apply a beam state to a subsequent communication (545).

In further detail, a wireless communication node (e.g., BS 102 or 202) may determine or otherwise identify a beam state for a wireless communication device (e.g., UE 104 or 204) (505). The beam state may identify, define, or otherwise include one or more parameters for a beam to be used by the wireless communication device in communication with the wireless communication node. The beam state may include quasi-co-location (QCL) information, a transmission configuration indicator (TCI) state, spatial relation information, reference signal information, spatial filter information, or precoding information, among others.

The wireless communication node may send, provide, or otherwise transmit first downlink control information (DCI) to the wireless communication device (510). The first DCI may identify, include, or otherwise indicate the beam state to be used. With the identification of the beam state, the wireless communication node may generate the first DCI to indicate the beam state to the wireless communication device. In some embodiments, the wireless communication node may transmit the first DCI in a first component carrier (CC) of a group of CCs to the wireless communication device. Each CC may include or correspond to at least one bandwidth part (BWP). The wireless communication device may retrieve, identify, or otherwise receive the first DCI from the wireless communication node (515). In some embodiments, the wireless communication device may receive the first DCI in the first CC of the group of CCs from the wireless communication node. Upon receipt, the wireless communication device may parse the first DCI to extract or identify the beam state indicated by the first DCI.

The wireless communication device may identify, set, or otherwise determine a first application time (e.g., t1) (520). The first application time may be to apply the beam state indicated by the first DCI to the communications between the wireless communication device and the wireless communication node. The first application time may be determined in accordance with a reference time or a time offset (e.g., t2), or a combination of both, among others. In some embodiments, the first application time may be determined by the wireless communication node and may be indicated to the wireless communication device via the first DCI. Both the reference time or time offset for the first application time may be assigned, measured, or otherwise identified in terms of time units. In some embodiments, the time unit may identify, correspond to, or include at least one of: a subframe, a frame, an orthogonal frequency-division multiplexing (OFDM) frame, a millisecond, a microsecond, a second, a slot, a symbol, or an OFDM symbol, among others.

For example, a UE applies the beam state to at least one target transmission starting from or after the first slot that is after slot k+X(time unit, e.g. slot). X may be an integer, and k may be the slot for a reference of the application time, such as the slot where the UE receives the first DCI, or the slot where the UE would transmit a PUCCH or PUSCH with HARQ-ACK information for the first DCI, or the slot where the UE would transmit a PUCCH or PUSCH with HARQ-ACK information for the PDSCH scheduled by the first DCI. X may be a predefined value, or a value indicated by the first DCI, or a value configured by RRC or MAC-CE. For instance, a UE may apply the beam state to at least one target transmission starting from the first slot that is after slot k+X Nₛₗₒₜ^{frame,μ} where Nₛₗₒₜ^{frame,μ}, is number of slots per frame for subcarrier spacing configuration μ, and k is the slot where the UE would transmit a PUCCH or PUSCH with HARQ-ACK information for the PDSCH providing the MAC CE and μ is the SCS configuration for the PUCCH or PUSCH, respectively. X may be a predefined value (e.g., 3).

The reference time may identify or correspond to a time relative to receipt of the first DCI or otherwise scheduled by the first DCI (e.g., before or after). In some embodiments, the reference time may be identified or included in the first DCI. In some embodiments, the reference time may identify, correspond to, or include: a time unit during which the wireless communication device receives the first DCI; a time unit during which the wireless communication device would transmit a physical uplink control channel (PUCCH) or a physical uplink shared channel (PUSCH) with hybrid automatic repeat request acknowledgement (HARQ-ACK) information for the first DCI; and a time unit during which the wireless communication device would transmit a PUCCH or PUSCH with HARQ-ACK information for a physical downlink shared channel (PDSCH) scheduled by the first DCI, among others.

The time offset may identify or correspond to a time relative to the reference time (e.g., before or after). In some embodiments, the time offset may be identified or included in the first DCI. In some embodiments, the time setoff may identify, correspond to, or include X time units. X may be a predefined value, a value indicated by the first DCI, or a value configured by radio resource control (RRC) or medium access control control element (MAC-CE) signaling, among others. In some embodiments, X may be a value indicated by a time domain resource assignment (TDRA) field in the first DCI. In some embodiments, the value X may be indicated to the wireless communication device via a higher layer signaling (e.g., RRC) or MAC-CE signaling.

In some embodiments, according to the reference time and the time offset, the wireless communication device may determine the first application time. In some embodiments, the reference time and the time offset may be identified or indicated via the first DCI. In some embodiments, the wireless communication device may determine the first application time by applying the time offset relative to the reference time (e.g., after or before). In some embodiments, the wireless communication device may determine the first application time by applying the time set after a first time unit occurring relative to the reference time (e.g., after or before).

In some embodiments, the wireless communication device may determine the first application time using the group of CCs in which the first CC via which the first DCI is received. The time unit for the first application time may be in accordance with the first CC or the group of CCs in which the first CC belongs. In some embodiments, the time unit of the first application time may be determined in accordance with a smallest subcarrier spacing (SCS) amongst one or more SCS configurations of one or more active bandwidth parts (BWPs) in the group of CCs. The SCS may correspond to or may be defined in terms of a frequency domain and cyclic prefix. In some embodiments, the time unit of the first application time may be determined in accordance with a smallest of the one or more SCS configurations of the one or more active BWPs in the group of CCs and of one or more SCS configurations of an active BWP for a physical downlink control channel (PDCCH) reception. The active BWP may correspond to a contiguous set of resources in time and frequency domain for the communication.

In some embodiments, the wireless communication device may determine the first application time using transmission repetitions among the group of CCs. In some embodiments, the wireless communication device may determine the first application time in accordance with a completion time of a set of transmission repetitions of a first target transmission in one CC of the group of CCs. The set of transmission repetitions may correspond to the completion of one transmission (e.g., PDSCH or PUSCH) prior to the target transmission in one CC of the group of CCs. In some embodiments, the wireless communication device may determine the first application time or a minimum value of the first application time based on a capability of the wireless communication device. The capability may be for a CC or a group of CCs for a band or band group, for a BWP, or for a SCS configuration, among others. In some embodiments, the capability of the wireless communication device may be reported from the wireless communication device to a wireless communication node. In some embodiments, the wireless communication device may determine the first application time or the minimum value of the first application time configured or indicated by the wireless communication node. In some embodiments, the first application time or the minimum value of the first application time may be configured or indicated by the wireless communication node for a CC or CC group, for a band or band group, for a BWP, or for each SCS configuration.

The wireless communication device may apply the beam state to a communication with the wireless communication node (525). The communication (sometimes referred herein as a target communication or target transmission) between the wireless communication device and the wireless communication node may include, for example, PUCCH, PUSCH, PDCCH, PDSCH, SRS, and CSI-RS, among others. In some embodiments, the wireless communication device may determine whether to apply the beam state to the communication after or starting from the first application time. In some embodiments, the wireless communication device may determine whether to apply the beam state to the communication on at least one CC of the group of CCs after or starting from the first application time. In determining, the wireless communication device may identify whether the beam state is applicable to the communication after or starting from the first application time as indicated in the first DCI. When the beam state is identified as applicable, the wireless communication device may apply the beam state to the communication after or starting from the first application time. In some embodiments, while applying the beam state, the wireless communication device may measure, identify, or otherwise determine pathloss information after or starting from the first application time for the communication according to the beam state. Otherwise, when the beam state is identified as not applicable, the wireless communication device may refrain from applying the beam state to the communication.

The wireless communication node may send, provide, or otherwise transmit second DCI to the wireless communication device (530). The second DCI may identify, include, or otherwise indicate a beam state to be used. The beam state indicated by the second DCI may be the same or may be different from the beam state indicated by the first DCI. The second DCI may occur after the first DCI or after the communication (e.g., the SRS). In some embodiments, the second DCI may be before a time period after the communication (e.g., the SRS transmission). With the identification of the beam state, the wireless communication node may generate the second DCI to indicate the beam state to the wireless communication device. In some embodiments, the wireless communication node may transmit the second DCI in one component carrier (CC) of the group of CCs to the wireless communication device. In some embodiments, the wireless communication node may transmit the second DCI with a type A DCI format. The type A DCI format may identify or include a DCI format 0_0. In some embodiments, the wireless communication node may transmit the second DCI with a type B DCI format. The type B DCI format may identify or include a DCI format 0_1, DCI format 0_2, or an uplink DCI format other than DCI format 0_0, among others. The value of identifier for DCI formats field may be set to 0 to indicate an UL DCI format.

The wireless communication device may retrieve, identify, or otherwise receive the second DCI from the wireless communication node (535). In some embodiments, the wireless communication device may receive the second DCI in one CC of the group of CCs from the wireless communication node. In some embodiments, the wireless communication device may receive the second DCI with the type A DCI format. In some embodiments, the wireless communication device may receive the second DCI with the type B DCI format. Upon receipt, the wireless communication device may parse the second DCI to extract or identify the beam state indicated by the second DCI. The beam state indicated by the second DCI may be the same or may be different from the beam state indicated by the first DCI.

The wireless communication device may identify, set, or otherwise determine a second application time (540). The second application time may be to apply the beam state indicated by the second DCI to the communications between the wireless communication device and the wireless communication node. In some embodiments, the second application time may be the same as the first application time. In some embodiments, the wireless communication device may identify the first application time from the second DCI. In some embodiments, the second application time may be different from the first application time. In some embodiments, the wireless communication device may determine the second application time in a similar manner as described above with reference to the determination of the first application time.

In some embodiments, the wireless communication device may determine the second application time based on the second DCI or one or more previous transmissions. In determining the second application time, the wireless communication device may detect or identify a latest communication (e.g., PUSCH, PDSCH, PUCCH, PDCCH, CSI-RS, or SRS transmission) in time domain. The identification of the latest communication in the time domain may be based on the communication, a transmission of the second DCI, or a reception of the second DCI. The latest communication in the time domain may correspond to or include a latest communication. The latest communication may correspond to or include a latest applicable communication (e.g., PUSCH, PDSCH, PUCCH, PDCCH, CSI-RS, or SRS transmission) occurring before the start of the previous communication or before the completion of the transmission or reception of the second DCI. In some embodiments, the latest applicable communication may include a communication that becomes applicable after the second application time. In some embodiments, the wireless communication device may determine the second application time in accordance with the communication (e.g., PUSCH, PDSCH, PUCCH, PDCCH, CSI-RS, or SRS) scheduled by the second DCI. The second application time may be relative to the communication (e.g., after or starting from the completion of the communication).

The wireless communication device may apply a beam state to a subsequent communication (545). The subsequent communication (sometimes referred herein as a target communication or target transmission) between the wireless communication device and the wireless communication node may include, for example, PUCCH, PUSCH, PDCCH, PDSCH, SRS, and CSI-RS, among others. The beam state to be applied to the subsequent communication may be in accordance with the second DCI. In some embodiments, the wireless communication device may determine whether to apply the beam state to the communication (e.g., PUSCH) occurring after or starting from the first application time (or the second application time that correspond to the first application time). The subsequent communication may be scheduled by the second DCI. In determining, the wireless communication device may identify whether the beam state is applicable to the subsequent communication after or starting from the first (or second) application time as indicated in the second DCI.

When the beam state is identified as applicable, the wireless communication device may apply the beam state to the subsequent communication after or starting from the second application time. In applying, the wireless communication device may identify or determine a transmit parameter for the communication between the wireless communication device and the wireless communication node. The determination of the transmit parameter may be in accordance with the latest communication (e.g., SRS transmission) in the time domain based on the subsequent communication, the transmission of the second DCI, or the reception of the second DCI. The transmit parameter may identify or include, for example, a transmission precoder, precoding information, transmit or receipt beam state, and transmit or receipt filter parameter, among others. For instance, the receipt beam state may be provided by the wireless communication node to the wireless communication device for determining the transmit beam state. The wireless communication node may provide the wireless communication device a PUSCH communication using a beam corresponding to the receipt beam defined in terms of DL RS or synchronization signal block (SSB) resource. The wireless communication device may determine the transmit beam state according to a pre-trained beam pair. Otherwise, when the beam state is identified as not applicable, the wireless communication device may refrain from applying the beam state to the subsequent communication.

Upon determining to apply to apply, the wireless communication device may determine whether to use the second DCI to apply to the subsequent communication based on the type of communication. In some embodiments, the wireless communication device may determine to apply the beam state to the subsequent communication (e.g., when the subsequent communication is PUSCH) when the second DCI occurs after the first application time. In some embodiments, the wireless communication device may determine to apply the beam state to the subsequent communication (e.g., when the subsequent communication is SRS transmission) after the first application time. For example, the first application time may be for a target transmission which also include SRS transmission.

In some embodiments, the wireless communication device may determine to apply the beam state to the subsequent communication (e.g., PUSCH) scheduled by the second DCI when at least one condition is met. In some embodiments, the condition may identify or include the second DCI is of a type B DCI format. In some embodiments, the condition may identify or include a rank value or a maximum rank value of the communication (e.g., PUSCH transmission) is 1. In some embodiments, the condition may identify or include a number of layer, transmission layer, or maximum layer of communication (e.g., PUSCH transmission) is 1. In some embodiments, the condition may identify or include a number of port or antenna port of the PUSCH transmission is 1. In some embodiments, the condition may identify or include a number of demodulation reference signal (DMRS) port of the PUSCH transmission is 1. In some embodiments, the condition may identify or include a sounding reference signal (SRS) resource indicator (SRI) field is not present in the second DCI. In some embodiments, the condition may identify or include absence of a SRS request field in the second DCI, or a SRS field of the second DCI is set with a value of 0. In some embodiments, the condition may identify or include a special transmit precoding matrix index (TPMI) parameter is set with a predefined value in the second DCI. In some embodiments, the condition may identify or include a precoding information and number of layers field in the second DCI is set as a reserved value. In some embodiments, the condition may identify or include a PUSCH repetition Type A is configured or indicated for the PUSCH transmission, and a number of repetitions that is larger than 1. When at least one of the conditions is satisfied, the wireless communication device may apply the beam state to the subsequent communication scheduled by the second DCI. Otherwise, when none of the conditions are satisfied, the wireless communication device may refrain from the beam state to the subsequent communication.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a wireless communication device from a wireless communication node in a first component carrier (CC) of a group of CCs, a first downlink control information (DCI) indicating a beam state; and
determining, by the wireless communication device, to apply the beam state to at least one target transmission on at least one CC of the group of CCs after or starting from a first application time.

2. The method of claim 1, wherein the first application time is determined according to at least one of:
a reference time, or
a time offset.

3. The method of claim 2, wherein the first application time is determined by applying the time offset after the reference time, or by applying the time offset after a time unit occurring after the reference time.

4. The method of claim 2, wherein the reference time comprises one of:
a time unit during which the wireless communication device receives the first DCI,
a time unit during which the wireless communication device would transmit a physical uplink control channel (PUCCH) or a physical uplink shared channel (PUSCH) with hybrid automatic repeat request acknowledgement (HARQ-ACK) information for the first DCI, or
a time unit during which the wireless communication device would transmit a PUCCH or PUSCH with HARQ-ACK information for a physical downlink shared channel (PDSCH) scheduled by the first DCI.

5. The method of claim 2, wherein the time offset comprises X time units, wherein X is: a predefined value, a value indicated by the first DCI, or a value configured by radio resource control (RRC) or medium access control control element (MAC-CE) signaling.

6. The method of claim 3, wherein the time unit comprises at least one of: a subframe, a frame, an orthogonal frequency-division multiplexing (OFDM) frame, a millisecond, a microsecond, a second, a slot, a symbol, or an OFDM symbol.

7. The method of claim 1, wherein the beam state comprises at least one of: a quasi co-location (QCL) state, a transmission configuration indicator (TCI) state, spatial relation information, reference signal information, spatial filter information, or precoding information.

8. The method of claim 1, wherein a time unit of the first application time is determined according to at least one of:
a smallest subcarrier spacing (SCS) amongst one or more SCS configurations of one or more active bandwidth parts (BWPs) in the group of CCs; or
a smallest of the one or more SCS configurations of the one or more active BWPs in the group of CCs and of one or more SCS configurations of an active BWP for a physical downlink control channel (PDCCH) reception.

9. The method of claim 1, wherein the first application time is determined according to
a completion time of a set of transmission repetitions of a first target transmission in one CC of the group of CCs.

10. The method of claim 1, comprising:
determining, by the wireless communication device after or starting from the application time, pathloss information for the at least one target transmission, according to the beam state.

11. The method of claim 1, wherein:
the first application time or a minimum value of the first application time is based on a capability of the wireless communication device, or
the first application time or the minimum value of the first application time is configured or indicated by the wireless communication node.

12. The method of claim 1, wherein:
the first application time or a minimum value of the first application time is determined based on a capability of the wireless communication device for a CC or CC group, for a band or band group, for a BWP, or for a SCS configuration, or
the first application time or the minimum value of the first application time is configured or indicated by the wireless communication node for a CC or CC group, for a band or band group, for a BWP, or for each SCS configuration.

13. The method of claim 1, comprising:
receiving, by the wireless communication device from the wireless communication node, a second DCI with a type A DCI format; and
determining, by the wireless communication device, to apply the beam state to a first target transmission that occurs after or starting from the first application time, the target transmission comprising a physical uplink shared channel (PUSCH) scheduled by the second DCI,
wherein the type A DCI format comprises a DCI format 0_0.

14. The method of claim 1, comprising:
determining, by the wireless communication device, to apply the beam state to a sounding reference signal (SRS) transmission, after the first application time.

15. The method of claim 1, comprising:
receiving, by the wireless communication device from the wireless communication node, a second DCI with a type B DCI format; and
determining, by the wireless communication device, a transmit parameter of the target transmission, according to a latest SRS transmission in time domain based on the target transmission, or a transmission or reception of the second DCI.

16. The method of claim 15, wherein:
the latest SRS transmission in time domain comprises a latest SRS transmission or a latest applicable SRS transmission occurring before the target transmission, or before the transmission or reception of the second DCI,
the type B DCI format comprises a DCI format 0_1, a DCI format 0_2, or a uplink DCI format other than DCI format 0_0, or
the second DCI occurs after the first DCI or after the SRS, and before a first time period after the SRS transmission.

17. A wireless communication device comprising:
at least one processor configured to:
receive, via a receiver from a wireless communication node in a first component carrier (CC) of a group of CCs, a first downlink control information (DCI) indicating a beam state; and
determine to apply the beam state to at least one target transmission on at least one CC of the group of CCs after or starting from a first application time.

18. A wireless communication node comprising:
at least one processor configured to:
transmit, via a transmitter to a wireless communication device in a first component carrier (CC) of a group of CCs, a first downlink control information (DCI) indicating a beam state; and
cause the wireless communication device to apply the beam state to at least one target transmission on at least one CC of the group of CCs after or starting from a first application time.

19. A method comprising:
transmitting, by a wireless communication node to a wireless communication device in a first component carrier (CC) of a group of CCs, a first downlink control information (DCI) indicating a beam state; and
causing the wireless communication device to apply the beam state to at least one target transmission on at least one CC of the group of CCs after or starting from a first application time.
